(19) United States
(12) Patent Application Publication
(10) Pub. No.: US 2009/0160867 A1
(43) Pub. Date: Jun. 25, 2009

(54) Autonomous Context Scheduler For Graphics Processing Units

(75) Inventor: Mark S. Grossman, Palo Alto, CA (US)

Correspondence Address: COURTNEY STANIFORD & GREGORY LLP, P.O. BOX 9686, SAN JOSE, CA, 95157, US

(73) Assignee: Advance Micro Devices, Inc., Sunnyvale, CA (US)

(21) Appl. No.: 11/960,305

(22) Filed: Dec. 19, 2007

(51) Int. Cl. G06T 1/00

(52) U.S. Cl. 345/522

(57) ABSTRACT

Embodiments directed to an autonomous graphics processing unit (GPU) scheduler for a graphics processing system are described. Embodiments include an execution structure for a host CPU and GPU in a computing system that allows the GPU to execute command threads in multiple contexts in a dynamic rather than fixed order based on decisions made by the GPU. This eliminates a significant amount of CPU processing overhead required to schedule GPU command execution order, and allows the GPU to execute commands in an order that is optimized for particular operating conditions. The context list includes parameters that specify task priority and resource requirements for each context. The GPU includes a scheduler component that determines the availability of system resources and directs execution of commands to the appropriate system resources, and in accordance with the priority defined by the context list.

### TECHNICAL FIELD

The disclosed embodiments relate generally to graphics processors, and more specifically to methods and apparatus for autonomous scheduling of command threads in a graphics processing unit.

### BACKGROUND OF THE DISCLOSURE

A graphics processing unit (GPU) is a dedicated graphics rendering device for computers, workstations, game consoles, and similar digital processing devices. A GPU is usually implemented as a co-processor component to the central processing unit (CPU) of the computer, and may be provided in the form of an add-in card (e.g., video card), co-processor, as functionality that is integrated directly into the motherboard of the computer or into other devices (such as, for example, Northbridge devices and CPUs). Typical graphics processors feature a highly parallel structure that is optimized for manipulating and displaying the graphics data used in complex graphical processing algorithms. A GPU typically implements a number of graphics primitive operations that render 2D and 3D graphic images much faster than a CPU drawing directly to the display.

Graphics processing units can often execute various different command threads for different applications, with each command thread representing a context of the GPU. In general, a processor context represents a set of data that describes the state of the processor and other processors during the execution of a command thread, and may include the state of data registers, which contain intermediate results of whatever operation is currently being performed, or control registers that change the processor's behavior when it performs certain operations. Graphics processors usually have a great deal more state information in control registers than general-purpose microprocessors due to their pipelined and fixed function architecture. In general, a great deal of control register state information is required for the operations performed by a GPU. For example, a set of control registers may include texture map definitions (addresses and dimensions), texture addressing and filtering modes, blending operations for texture values and interpolated color values, and various other graphics functions.

In present GPU systems, a context usually includes a set of commands that are arranged in a ring, or similar execution structure. Each context has its own command buffer or command buffer pointer to memory that contains executable commands. When the processor switches context, it switches the ring from which commands are pulled. The GPU then reads the commands from memory and executes them. The commands also define the operating state of the GPU with regard to texture mapping, bit per pixel definition, and other functions. At any point during execution, the context has associated with it the particular state of the GPU at that particular time.

Although graphics processors may contain and execute their own set of commands, the host CPU and operating system is typically the sole determinant of which graphics contexts are executed on a GPU, and in what order. The processor schedule for the GPU is typically provided in the form of a pre-defined ordered list of contexts. The contexts are executed by the GPU sequentially in the order provided by the list. The list order may be defined based by various considerations, such as the relative importance of the context based on priority and age, and other factors, such as processor bandwidth and memory availability, and synchronization dependencies. Once the order is defined in the list, contexts cannot easily be executed out of sequence. This simple sequential scheduling model may ensure coordinated processing by the separate processing units, but it represents a significant limitation on GPU processing capability as the order of execution is strictly defined by the host CPU in a pre-defined manner that may not optimally account for specific system characteristics at runtime. Thus, present GPU scheduling systems may not allow the GPU to operate at its maximum potential given the resources available during runtime.

As compared to systems in which the GPU processing schedule is strictly controlled by the host CPU at runtime, the ordered list of contexts does allow for some autonomous context switching by the GPU due to various factors, such as resource faults and speed of completion of tasks. FIG. 1 illustrates an example of a pre-defined context list executed by a GPU as presently known. As shown in FIG. 1, the context list 100 contains a number of contexts labeled 1 to N, each containing a number of context parameters, such as, context numbers, pointers to memory, and other relevant execution parameters. During normal execution, the GPU executes commands sequentially through the contexts in the order that the commands are presented in each ring or command execution structure. If the GPU finishes execution of a context early, it is allowed to automatically proceed with the next context on the list without requiring direct host CPU intervention.

The use of a pre-defined, ordered list of contexts allows the GPU to execute certain command threads as if it were independent of the host CPU. However, this method requires the definition of predetermined context lists, and can thus only accommodate a limited number of applications and processing scenarios. Furthermore, the use of pre-defined context lists limits any type of optimization to a particular GPU implementation. Such a system does not easily allow for autonomous processing as GPU architecture and firmware develops. This prevents such systems from easily exploiting new GPU developments to fashion efficient processing schedules. What is needed, therefore, is a GPU command thread execution system that allows the GPU to make processing decisions independently of the host CPU in order to efficiently exploit the processing capabilities of the GPU.

### BRIEF DESCRIPTION OF THE DRAWINGS

Embodiments are illustrated by way of example and not limitation in the figures of the accompanying drawings, in which like references indicate similar elements and in which:

FIG. 1 illustrates an example of a pre-defined context list executed by a GPU as presently known;

FIG. 2 illustrates an unordered set of contexts for execution by a GPU in an autonomous GPU scheduling system, under an embodiment;

FIG. 3 is a table that illustrates the priority and resource parameters for the context list of FIG. 2, under an embodiment;

FIG. 4 is a flowchart that illustrates control of a GPU using a context list containing comprehensive priority and resource parameters, under an embodiment; and

FIG. 5 is a block diagram of a GPU system incorporating an autonomous GPU context scheduler, under an embodiment.

### DETAILED DESCRIPTION

Embodiments of the invention as described herein provide a solution to the problems of conventional methods as stated above. In the following description, various examples are given for illustration, but none are intended to be limiting. Embodiments include an execution structure for a host CPU and GPU in a computing system that allows the GPU to execute command threads in multiple contexts in a dynamic rather than fixed order based on decisions made by the GPU. This eliminates a significant amount of CPU processing overhead required to schedule GPU command execution order, and allows the GPU to execute commands in an order that is optimized for particular operating conditions.

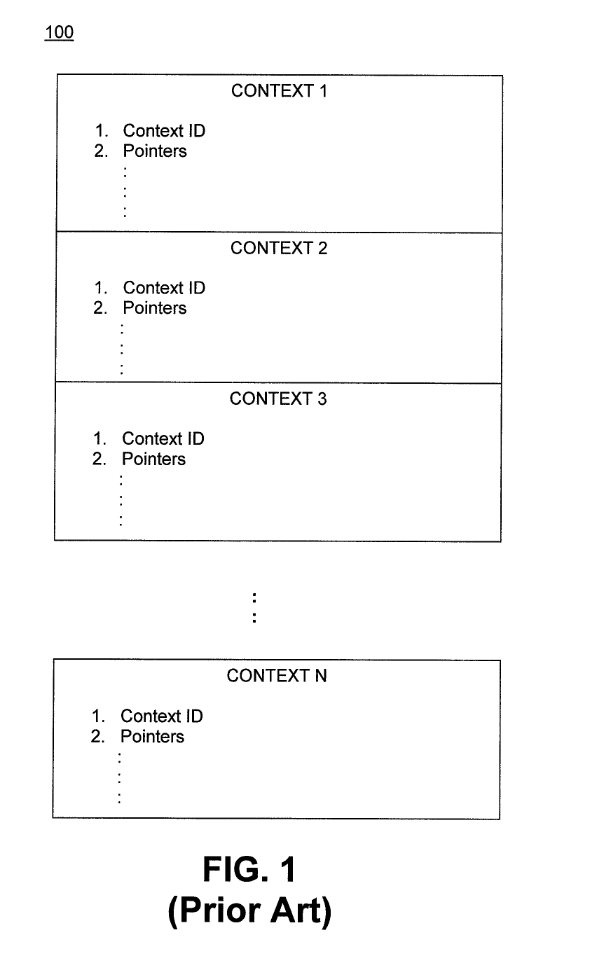

As shown in FIG. 1, present systems of context execution in present GPU control systems require the GPU, during normal execution cycles, to execute commands in the order set by the pre-defined set of contexts provided by the operating system regardless of specific system or application characteristics. The pre-defined ordered list of contexts 100 are provided by the operating system through the host CPU to the GPU for execution. For the embodiment of FIG. 1, each context contains working data, pointers and scheduling information for executable program instructions. During runtime, the contexts are processed or executed by the GPU. In one embodiment, an autonomous GPU scheduler system includes a context list that includes additional parameters that facilitate non-sequential execution of listed contexts by the GPU. Instead of executing contexts in a strictly sequential manner, the GPU can execute contexts in any appropriate order for optimum performance and efficiency, as based on task priority and resource requirements specified in the context list itself. In addition, the GPU includes a scheduler component that determines the availability of system resources and directs execution of commands to the appropriate system resources, and in accordance with the priority defined by the context list.

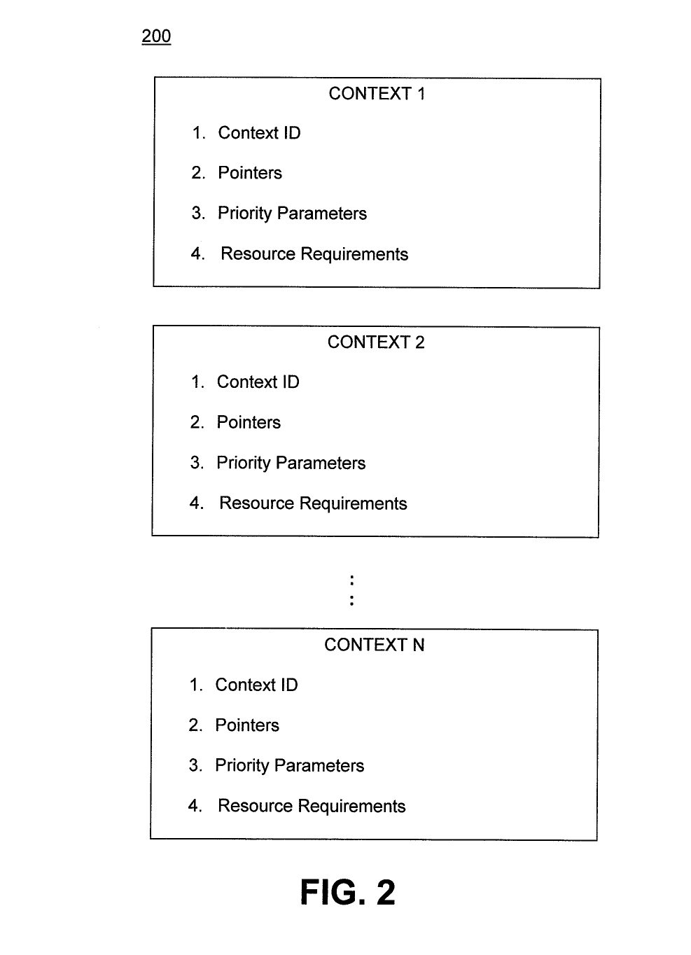

FIG. 2 illustrates an unordered set of contexts for execution by a GPU in an autonomous GPU scheduling system, under an embodiment. As shown in FIG. 2, a set of contexts 200 are available for execution by the GPU. Each context of FIG. 2 includes commands that define the operating state of the GPU, e.g., what kind of texture mapping is used, how many bits per pixel are defined in the frame buffer, and so on. The context also includes other data such as pointers to buffers or memory addresses that may be written to or read from. The memory for the buffers may be accessed through a virtual memory system that utilizes page tables, Translation Lookaside Buffers (TLB), pointers to which table is being used, and so on. Different contexts generally use different buffers or sets of buffers. Each context of FIG. 2 includes a context identifier and one or more pointers to buffer or other memory locations for read/write operations. Each context also includes one or more parameters related to the prioritization of the task or command thread of the context, and one or more parameters related to the resources used or required by the context, as well as any additional parameters.

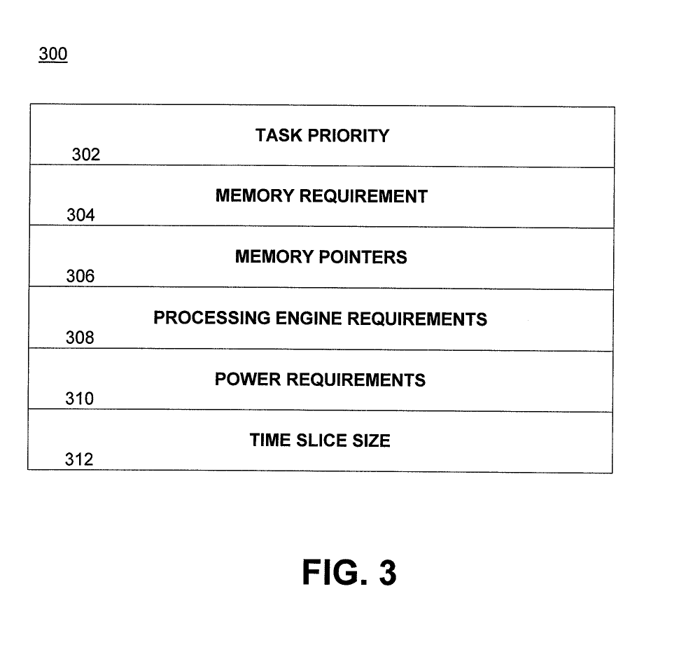

FIG. 3 is a table that illustrates the priority and resource parameters for the context list of FIG. 2, under an embodiment. The priority parameters of table 300 include a task priority level 302 that indicates the importance or priority level of the task relative to other tasks executed by the GPU. The priority level value can be coded in the form of a scalar value or other relative valuation scheme, and can be defined by the operating system, application software or user input.

The resource requirements parameters include a memory requirement context parameter 304 that specifies the amount of memory that is required by the context. A detailed list of buffer or memory pointers 306 that are made accessible to the system is also provided. For systems that include multiple GPUs or other processing engines that can execute the commands of the context, parameter 308 defines the number of engines that are required or can be used for execution, and/or the identification of specific processing engines for execution of the commands. The power budget parameter 310 specifies the approximate power consumption or requirements of the context, and is largely dependent on the number of engines parameter 308, or the size of the context. This allows contexts to run in a certain order depending upon system constraints, such as battery use, unreliable power supply, and so on. In one embodiment, the resource requirements can be provided by either the operating system or device driver software. Alternatively, the resource requirements or preferences may be supplied by the user through a graphical user interface. For example, a user may elect to run the processor anywhere in range between maximum performance mode (maximum clock speed and power consumption) and power savings mode (minimum clock speed and power consumption). Based on this user selection, the GPUs are configured to assign commands to the appropriate resource depending on the resource profiles of each individual engine.

The context parameter list 300 also includes general parameters, such as parameter 312, which specifies the size of the time slice for the context. In order to allow the contexts to be run with some degree of regularity, the time slice parameter allows the system to define time slices of appropriate length for each context of multiple contexts. The time slice size parameter essentially specifies a maximum amount of time allotted to execute program instructions for each context scheduled. In the event that a context is too long relative to other contexts, the time slice parameter can be configured to trigger a context switch after a preset amount of time to allow other contexts to execute without undue delay.

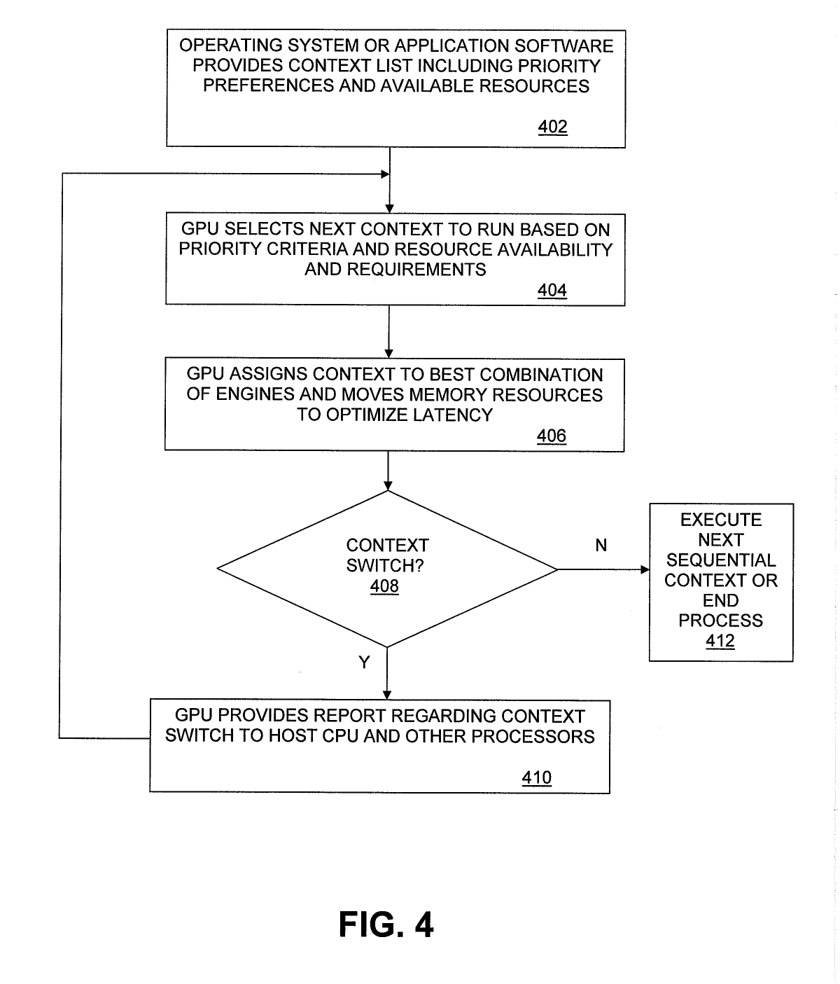

FIG. 4 is a flowchart that illustrates control of a GPU using a context list containing comprehensive priority and resource parameters, under an embodiment. As shown in block 402, the operating system or application software provides a list of contexts that the GPU is to execute, with each context containing corresponding priority and resource parameters, such as shown in FIGS. 2 and 3. In block 404, the GPU selects a next context to run based on the priority parameter 302, and one or more of the resource parameters, such as memory, engine or power requirements, and other parameters, such as time slice size, 312. The GPU then allocates appropriate resources to the context, such as by assigning the context to the best combination of processing engines, block 406. In this step, the GPU may also move memory to optimize latency. For this embodiment, the system may include different memories distributed across the system or within the one or more processors. For example, the CPU may have its own memory and the GPU may have a different set of memory. In this case, it may be advantageous to move data to memory that is closest to either the GPU or CPU or to memory that is faster for the context commands, in order to reduce memory access times.

During normal command thread execution, the GPU will complete all processing associated with a context before starting a new context. In normal operation, the next context to be executed is typically the next sequential context in the list. However, for optimum performance, or to take advantage of system resources, it may be preferable to select the next context to be executed on the basis of priority level and/or resource requirements, as shown in block 404. Furthermore, in certain cases, execution of a context may be interrupted during a context switch (context transition) operation in which the GPU switches to a different context prior to completion of a present context. In block 408, the system determines whether a context switch is to be made. A context switch refers to the execution of a context which is not the next sequential context following the presently executed context. Alternatively, a context switch may be required if a fault or exception condition exists, or if resources or the time slice for the present context run out, or any other interrupt condition occurs. If no context switch is required, the GPU executes the next context in sequence or ends the process is no further contexts are to be executed and all processing has been completed, block 412.

In the event of a context switch, the GPU control system is configured to report relevant information regarding the context switch before proceeding with executing the next context. As shown in block 410, the GPU generates a report to the operating system that indicates that a context transition occurred. The report provides a number of relevant data points, such as time spent on the original context, resources used by the original context, any memory that may have been moved, any resources that may not be available, and other appropriate information regarding the original context, and of the switch event. The report also includes a pointer or indicator to the last command executed in the interrupted context so that execution can be re-commenced at a later time.

In some systems, multiple graphics processors or other co-processors may be available for use. In these systems, the different GPUs utilize the same context list for operation. For this embodiment, the host CPU or each GPU individually coordinates its activities with the other GPUs based on the reports so that each of the multiple GPUs can self-schedule their execution of respective contexts from the list. For this embodiment, a lock-out mechanism is provided to prevent multiple GPUs from interfering with the same context.

In one embodiment, the GPU executes a decision process that ranks the relative importance of the parameters and weighs each parameter accordingly. For example, the priority parameter may be selected to override all other parameters, so that a high priority task may always be given execution precedence over tasks that have lower priority, but may require far fewer resources or time slice size. Alternatively, the GPU may be configured to execute contexts that require the least amount of time or a significantly smaller amount of resources ahead of contexts that may be higher priority but may take much longer or require more resources. Various different prioritization schemes may be implemented depending upon system constraints and requirements, and based on various combinations of prioritization levels and resource requirements for the contexts.

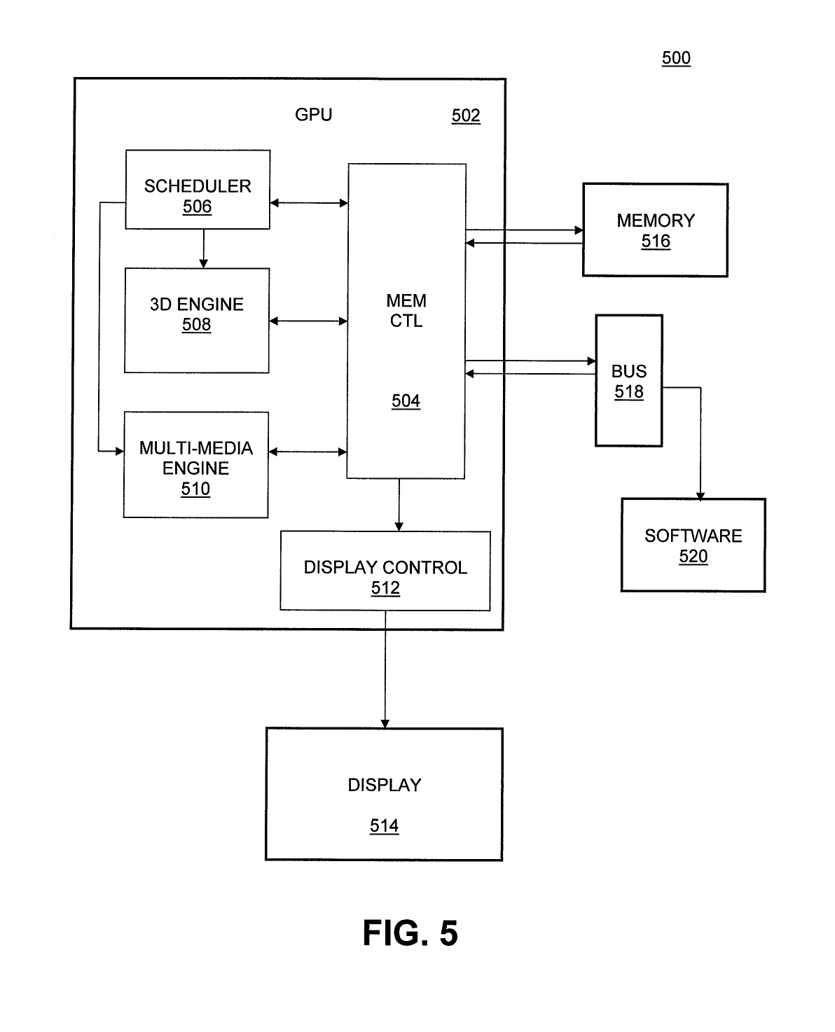

In one embodiment, the autonomous GPU context scheduler process is implemented as logic functionality provided in the GPU itself. FIG. 5 is a block diagram of a GPU system incorporating an autonomous GPU context scheduler, under an embodiment. The system 500 of FIG. 5 includes GPU 502 and several external components that may be part of a single processing device or distributed among various different devices. GPU 502 includes a memory controller 504, which reads and writes to memory 516. It also includes several graphic processing engines, such as 3D engine 508 and multimedia engine 510, among other similar engines. These engines read and write to memory 516 through memory controller 504. A display controller 512 receives commands from memory controller 504 and outputs the appropriate signals to display 514. Memory controller 504 also communicates to the system running the OS and application software components 520 through an external bus 518. For the case where the GPU system 502 is an external graphics card, the interface to bus 518 may be through a peripheral component interconnect (PCI) interface or PCIe (PCI express) interface, or any similar interface.

In one embodiment, software system 520 includes the context list, and the GPU 502 includes a scheduler component 506. The context list contains the priority and resource parameters that are used by scheduler 506 to determine which context to execute at any given time. The scheduler accesses the appropriate engines 508 and 510, as well as system memory 516 to determine resource availability and effect command execution from the present context by the appropriate components. The scheduler 506 effectively replaces the scheduling function provided by the operating system with regard to GPU functionality. Traditional OS schedulers limited GPU execution of contexts to very simple sequential execution, or must schedule a single context at a time based on the operating system's evaluation of task priorities and GPU resources. The scheduler 506 in conjunction with the expanded context list including priority and resource parameter information allows for dynamic scheduling of contexts by the GPU itself. A much larger context list can be provided, and such a list need not be defined or provided to the GPU in any particular order. This greatly reduces the amount of work needed in preparing or defining context lists to graphic systems, as scheduling need not be pre-determined, but can instead be optimally determined by the GPU itself. In one embodiment, the operating system may supply scheduler 506 with some global scheduling parameters that are not specific to individual contexts, such as the maximum time slice allowed for any context.

The scheduler 506 may utilize any type of appropriate scheduling mechanism to manage the assignment of priorities to the contexts in a priority queue, or similar mechanism. In one embodiment, the scheduler may use a ready queue to decide which contexts are to be executed and in what order. The scheduler may include a dispatcher component that decides which of the ready, in-memory contexts are to be executed next following a clock interrupt, an IO (input/output) interrupt, an operating system call or similar signal.

In general, the host CPU may be configured to control the list of active contexts for the GPU 502 to run in a variety of different ways. In one embodiment, the host CPU provides over the communication bus, a complete updated list to the GPU whenever the running status or priority of threads or applications changes. Alternatively it may send commands to provide individual updates to elements of a list, such as through commands like: Add_context(x), Remove_context(x), or Update_context(x).

Likewise, the GPU may communicate status back to the host CPU in a variety of ways. One method is to send an interrupt accompanied by detailed status whenever a context switch occurs on one of the GPU processing elements. Details include whether the context completed normally, whether it terminated abnormally and why, what time the switch occurred, a list of memory resources the CPU must provide for the context to run again. Another method is to send a list to the CPU periodically or upon request, containing the aforementioned details for some or all contexts, plus information such as queue position and current run status.

The embodiments described herein reduce the dependency on software or operating system processes with regard to scheduling of commands for execution by the GPU or multiple GPUs in a graphics processing system. Embodiments may be provided as software drivers that control operation of the GPU, or it may be provided as functionality coded directly into the GPU.

Although embodiments have been described with reference to graphics processors, or visual processing units (VPU), which are dedicated or integrated graphics rendering devices for a processing system, it should be noted that such embodiments can also be used for many other types of hardware-based co-processors, such as, Arithmetic Logic Units (ALU), math co-processors, digital signal processing (DSP) processors, sound processors, and any other type of processing circuit that supplements a general-purpose CPU. Such co-processors may be provided as additional hardware in the form of separate IC (integrated circuit) devices or as add-on cards for systems.

In one embodiment, the system including the GPU control system comprises a computing device that is selected from the group consisting of: a personal computer, a workstation, a handheld computing device, a digital television, a media playback device, smart communication device, and a game console, or any other similar processing device.

Aspects of the system described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects of the autonomous GPU scheduling system may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments of the autonomous GPU scheduling system is not intended to be exhaustive or to limit the embodiments to the precise form or instructions disclosed. While specific embodiments of, and examples for, processes in graphic processing units or ASICs are described herein for illustrative purposes, various equivalent modifications are possible within the scope of the disclosed methods and structures, as those skilled in the relevant art will recognize.

The elements and acts of the various embodiments described above can be combined to provide further embodiments. These and other changes can be made to the disclosed system in light of the above detailed description.

In general, in the following claims, the terms used should not be construed to limit the disclosed method to the specific embodiments disclosed in the specification and the claims, but should be construed to include all operations or processes that operate under the claims. Accordingly, the disclosed structures and methods are not limited by the disclosure, but instead the scope of the recited method is to be determined entirely by the claims.

While certain aspects of the disclosed embodiments are presented below in certain claim forms, the inventors contemplate the various aspects of the methodology in any number of claim forms. For example, while only one aspect may be recited as embodied in machine-readable medium, other aspects may likewise be embodied in machine-readable medium. Accordingly, the inventor reserves the right to add additional claims after filing the application to pursue such additional claim forms for other aspects.

What is claimed is:

1. An apparatus comprising:
one or more processing engines configured to execute at least a portion of executable program instructions, said executable program instructions belonging to at least one context of a context list, the context list comprising a plurality of contexts, each context containing working data, pointers and scheduling information for the executable program instructions, and a priority level and resource requirements for the context; and
a scheduler coupled to the one or more processing engines and causing processing of contexts in the context list in an order determined by the priority level and resource requirements of the contexts.

2. The apparatus of claim 1 wherein the one or more processing engines comprise components of a graphics processing unit for coupling to the host CPU over an interface bus.

3. The apparatus of claim 2 wherein the resource requirements are selected from the group consisting of: memory requirements, available processing engines, and power consumption requirements.

4. The apparatus of claim 3 wherein each context further contains a context identifier, and one or more pointers to memory locations for read/write operations of the one or more processing engines.

5. The apparatus of claim 4 wherein each context further contains a time slice size parameter specifying a maximum amount of time allotted to execute program instructions for each context scheduled.

6. The apparatus of claim 1 wherein the scheduler includes a dispatcher module configured to switch execution from a first context to a second context in the event of context switch trigger.

7. The apparatus of claim 6 wherein the context switch trigger is selected from the group consisting of: a hardware fault condition, a software fault condition, a process exception condition, completion of execution of executable program instructions for the first context, and passage of a maximum amount of time available for completion of the executable program instructions for the first context, and wherein the maximum amount of time may be specified within the context or by a global system parameter.

8. The apparatus of claim 7 wherein the scheduler includes a reporting module configured to provide a report to a host CPU in the event of a context switch.

9. The apparatus of claim 8 wherein the report includes information items selected from the group consisting of: time spent in the first context, resources used for the first context, memory moved for the first context, and resources not available for the first context.

10. The apparatus of claim 6 wherein the scheduler defines the context processing schedule based on a prioritization scheme that weighs each of the priority level and resource requirements of each context relative to the priority level and resource requirements of the plurality of contexts.

11. The apparatus of claim 10 wherein the prioritization scheme assigns precedence of context execution to contexts with higher priority levels.

12. The apparatus of claim 10 wherein the prioritization scheme assigns precedence of context execution to contexts with lower resource requirements.

13. A method for scheduling command thread execution in a graphics processing unit (GPU), comprising:
defining a plurality of contexts containing working data, pointers and scheduling information for one or more command threads executed by the GPU;
specifying a relative priority for processing of each context of the plurality of contexts, within each respective context; and
determining an order of processing of each context of the plurality of contexts within a scheduling component of the GPU based on the relative priority of each context.

14. The method of claim 13 further comprising:
specifying resource requirements for the processing of each context of the plurality of contexts, within each respective context; and
wherein determining an order of processing of each context of the plurality of contexts within the scheduling component of the GPU is based on the relative priority and resource requirements of each context.

15. The method of claim 14 wherein the resource requirements are selected from the group consisting of: memory requirements, available processing engines, and power consumption requirements.

16. The method of claim 15 wherein the step of determining the order of processing further comprises determining an amount of time required to complete execution of the context.

17. The method of claim 16 wherein the scheduling component switches processing from a first context to a second context in the event of context switch trigger.

18. The method of claim 17 wherein the context switch trigger is selected from the group consisting of: a hardware fault condition, a software fault condition, a process exception condition, completion of execution of executable program instructions for the first context, and passage of a defined maximum amount of time available for completion of the executable program instructions for the first context.

19. The method of claim 18 wherein the scheduling component provides a report to a host central processing unit (CPU) in the event of a context switch.

20. The method of claim 19 wherein the report includes information items selected from the group consisting of: time spent processing the first context, resources used for the first context, memory moved for the first context, and resources not available for the first context.

21. A graphics processor control circuit comprising:
a bus interface circuit coupling a memory to one or more graphics processing engines contained in a graphics processing unit (GPU), wherein the memory stores a context list including a plurality of contexts, each context containing working data, pointers and scheduling information for executable program instructions, and a priority level for the context and resource requirements for the context;
a scheduler in the GPU determining an order of execution of contexts in the context list based on the priority level and resource requirements of the contexts.

22. The graphics processor control circuit of claim 21 wherein the bus interface circuit couples the GPU to a host central processing unit (CPU) in a graphics processing subsystem of a computing device, and wherein the computing device is selected from the group consisting of: a personal computer, a workstation, a handheld computing device, a digital television, a media playback device, and a game console.

23. The graphics processor control circuit of claim 22 wherein the resource requirements are selected from the group consisting of: memory requirements, available processing engines of the one or more graphics processing engines, and power consumption requirements.

24. The graphics processor control circuit of claim 23 wherein each context further contains a time slice size parameter specifying a maximum amount of time allotted to execute program instructions for each context scheduled.

25. The graphics processor control circuit of claim 24 wherein the scheduler includes a dispatcher module configured to switch execution from a first context to a second context in the event of context switch trigger, and wherein the context switch trigger is selected from the group consisting of: a hardware fault condition, a software fault condition, a process exception condition, completion of execution of executable program instructions for the first context, and passage of a maximum amount of time available for completion of the executable program instructions for the first context.

26. A method of operating a computer system comprising:
defining a plurality of contexts containing command threads for execution by a graphics processing unit (GPU); and
determining an order of execution of each context of the plurality of contexts within a scheduling component of the GPU based on a relative priority of each context and resource requirements of each context.

27. The method of claim 26 wherein the resource requirements comprises at least, in part, power consumption requirements.

28. The method of claim 26 wherein the power consumption requirements are dynamically adjusted based upon power constraints of said system.

29. The method of claim 29 wherein said order of execution is determined further based on at least one of system and user input available to said scheduling component.
